(19) United States
(12) Patent Application Publication
(10) Pub. No.: US 2004/0083199 A1
(43) Pub. Date: Apr. 29, 2004

(54) Method and architecture for data transformation, normalization, profiling, cleansing and validation

(76) Inventors: Diwakar R. Govindugari, San Jose, CA (US); David O. McGoveran, Boulder Creek, CA (US)

Correspondence Address: David O. McGoveran, 6221A Graham Hill Rd., #8001, Felton, CA, 95018, US

(21) Appl. No.: 10/635,891

(22) Filed: Aug. 5, 2003

Related U.S. Application Data
(60) Provisional application No. 60/401,324, filed on Aug. 7, 2002.
(60) Provisional application No. 60/401,325, filed on Aug. 7, 2002.
(60) Provisional application No. 60/401,321, filed on Aug. 7, 2002.
(60) Provisional application No. 60/401,322, filed on Aug. 7, 2002.

(51) Int. Cl. G06F 7/00

(52) U.S. Cl. 707/1

(57) ABSTRACT

This is a computer software architecture and method for managing data transformation, normalization, profiling, cleansing, and validation. In the preferred embodiment, the architecture and method includes seven integrated functional elements: Dispatcher to route data and metadata among system elements; Semantic Modeler to build semantic models; Model Mapper to associate related concepts between semantic models; Transformation Manager to capture transformation rules and apply them to data driven by maps between semantic models; Validation Manager to capture data constraints and apply them to data; Interactive Guides to assist the processes of semantic modeling and semantic model mapping; and Adapters to convert data to and from specialized formats and protocols.

### CROSS-REFERENCE TO RELATED APPLICATIONS

This application is a continuation of provisional patent applications Serial No. 60/401,324 (A Generic Infrastructure For Data Transformation, Normalization, Profiling, Cleansing And Validation), Serial No. 60/401,325 (A Tool For Mapping Between Data Repositories), Serial No. 60/401,321 (A Method For Reconciling Semantic Differences Between Interacting Web Services), and Serial No. 60/401,322 (A Recommender Agent For Aiding Mapping Between Ontologies Or Data Models, Or XML Documents), each filed Aug. 8, 2002 by the first named inventor, the contents of which are incorporated herein by reference.

### REFERENCES CITED

### U.S. PATENT DOCUMENTS

| | | | |
|---|---|---|---|
| 6,256,676 | Jul. 3, 2001 | Taylor, J. T., et al. | 709/246 |
| 5,809,492 | Sep. 15, 1998 | Murray, et al. | 706/45 |
| 5,913,214 | Jun. 15, 1999 | Madnick, et al. | 707/10 |
| 5,940,821 | Aug. 17, 1999 | Wical, K. | 707/3 |
| 5,970,490 | Oct. 19, 1999 | Morgenstern, M. | 707/10 |
| 6,038,668 | Mar. 14, 2000 | Chipman, et al. | 713/201 |
| 6,049,819 | Apr. 11, 2000 | Buckle, et al. | 709/202 |
| 6,092,099 | Jul. 18, 2000 | Irie, et al. | 709/202 |
| 6,076,088 | Jun. 13, 2000 | Paik, et al. | 707/5 |
| 6,226,666 | May 1, 2001 | Chang, et al. | 709/202 |
| 6,311,194 | Oct. 30, 2001 | Sheth, et al. | 715/505 |
| 6,424,973 | Jul. 23, 2002 | Baclawski, K. | 707/102 |
| 20020138358 | May 29, 2001 | Scheer,R. H. | 705/26 |
| 20030046201 | Apr. 8, 2002 | Cheyer, A. | 705/35 |
| 20030088543 | Oct. 7, 2002 | Skeen, M. D., et al. | 707/1 |

### OTHER PUBLICATIONS

Sowa, John F., Knowledge Representation: Logical, Philosophical, and Computational Foundations, Brooks/Cole, Pacific Grove, Calif., 2000.

Noy, N. F., and McGuinness, D., Ontology Development 101: A Guide to Creating Your First Ontology, Stanford University, Stanford, Calif., March, 2001.

Corcho, O., and Góbmez-Pérez, A., A Roadmap to Ontology Specification Languages in The Proceedings of the 12th International Conference on Knowledge Engineering and Knowledge Management, Universidad de Politecnica de Madrid, Madrid, Spain, October, 2000.

Ribière, M., and Charlton, P., Ontology Overview from Motorola Labs with a comparison of ontology languages, Motorola Labs, Paris, France, December, 2000.

Linthicum, D., Enterprise Application Integration, Addison-Wesley, Reading, Mass., 1999.

Cummins, F. A., Enterprise Integration: An Architecture for Enterprise Application and Systems Integration, John Wiley & Sons, New York, 2002.

Denny, M., Ontology Building: A Survey of Editing Tools, www.XML.com, O'Reilly & Associates, Palo Alto, Calif., 2000.

Calvanese, D., De Giacomo, G., and Lenzerini, M., Ontology of Integration and Integration of Ontologies, Proc. of the 2001 Description Logic Workshop, 2001.

Omelayenko, B., Integration of Product Ontologies for B2B Marketplaces: A Preview, SIGECOM, Vol. 2, Assoc. Computing Machinery, 2002.

McGuinness, D., Fikes, R., Rice, J., Wilder, S.: An Environment for Merging and Testing Large Ontologies. In: Proceedings of the Seventh International Conference on Principles of Knowledge Representation and Reasoning (KR2000), Breckenridge, Colo., Apr. 12-15, (2000).

Noy, N., Musen, M.: PROMPT: Algorithm and Tool for Automated Ontology Merging and Alignment. In: Proceedings of the AAAI-00 Conference, Austin, Tex. (2000).

Linthicum, D., Leveraging Ontologies & Application Integration, eAI Journal, May 2003.

Pollack, J. T., The Big Issue: Interoperability vs. Integration, eAI Journal, Oct. 2001.

Osterfelt, S., Business Intelligence: Data Diversity: Let It Be, DM Review, June 2002.

This is a computer software architecture and method for managing data transformation, normalization, profiling, cleansing, and validation. In the preferred embodiment, the architecture and method includes seven integrated functional elements: Dispatcher to route data and metadata among system elements; Semantic Modeler to build semantic models; Model Mapper to associate related concepts between semantic models; Transformation Manager to capture transformation rules and apply them to data driven by maps between semantic models; Validation Manager to capture data constraints and apply them to data; Interactive Guides to assist the processes of semantic modeling and semantic model mapping; and Adapters to convert data to and from specialized formats and protocols.

### BACKGROUND OF THE INVENTION

1. Field of the Invention

The present invention is related generally to what has become known in the computing arts as “middleware”, and more particularly to a unique semantics-driven architecture and method for data integration. Even more specifically, the architecture and method are to be used in systems to transform, normalize, profile, cleanse, and validate data of the type normally used to communicate business information between applications and business entities in an interconnected environment.

2. Review of the Prior Art

Many attempts have been made to solve the problem of automatically transforming data so as to maintain the meaning of the source and simultaneously the validity of the destination. This is the fundamental goal of data integration. In business, data integration is extremely important. Information in computerized form is often exchanged between users, software systems, software components, and businesses. Such exchanges form a cornerstone of most businesses and increasingly it is necessary that they be performed in real-time.

For example, consider the (overly simplified) processing of a purchase order by one business (the vendor) and produced by another business (the customer). The format and content of the purchase order are under the control of the customer. When the purchase order is received, it must be converted into an internal format used by the vendor for order fulfillment. Data values such as line items, unit prices, extended prices, totals, discounts, and so on must be validated. Line items may be inter-related and so relationships must be validated as well. The vendor's version of the purchase order may result in the generation of additional documents such as build orders, pick-lists, shipping documents, and the like.

Current data integration technology permits automation of some of these tasks, but leaves others to either manual resolution or highly specialized and inflexible software solutions. The incoming purchase order may contain numerous problems including unrecognizable abbreviations or names, non-standard units, spelling errors, incorrect parts numbers, invalid line items, invalid line item relationships, and so on. In fact, there is no guarantee that the items as ordered will be recognizable as items that are manufactured or sold. Note that, in the example under discussion, both the needs of the customer and of the vendor can change independently and unpredictably. Thus, even in this simplified example, any automated solution must be flexible and capable of continuous maintenance. The problem of recognizing and correcting such problems is inherent in data integration, but state of the art data integration does not offer an automated solution that is both flexible and capable of real-time application.

Data integration is both an integration strategy and a process. Data integration is a key part of EAI (enterprise application integration) as well as traditional ETL (extract-transform-load) operations. As an integration strategy, it involves providing the effect of having a single, integrated source for data. Historically, this strategy involved physically consolidating multiple databases or data stores into a single physical data store. Over time, software was developed that permitted users and applications to access multiple data stores while appearing to be a single, integrated source. Using such software for data integration is sometimes referred to as a federated strategy and in the current state of the art the software involved includes, for example, gateways and so-called portals. Ultimately, data integration strategies have come to mean any integration strategy that focuses on enabling information exchange between systems and therefore making the format and structure of data transparent either to users or application systems. Thus, data integration includes means to enable the exchange of information among, for example, individual users of software systems, software applications, and businesses, irrespective of the form of that information. For example, data integration technologies and methods include those that enable exchanges or consolidations of data composed in any form including as relational tables, files, documents, messages, XML, Web Services, and the like. Hereinafter, we will refer to any such data composition as a document, regardless of the type of composition, format of the data, or representation of data and metadata used. More recently, those familiar with the art have come to realize that data integration must also address various semantic issues (including, for example, those traditionally captured as metadata, schemas, constraints, and the like).

Achieving the goal of data integration involves providing a means for reconciling physical differences in data (such as format, structure, and type) that has a semantic correspondence among disparate systems (including possibly any number and combination of computer systems, application software systems, or software components). State of the art integration approaches establish semantic correspondence between data elements residing in different systems through either simplistic matching based on data element names, pre-defined synonyms, or establishing manual mapping between elements. Once the source and destination data elements are identified, various techniques are used to transform the source data format into that of the destination or perhaps into a common third format.

Certain tasks, such as data profiling, normalization, and cleansing, are sometimes performed a preparatory steps prior to data integration per se. Data profiling is the process of creating an inventory of data assets and then assessing data quality (e.g., whether there are missing or incorrect values) and complexity. It involves such tasks as analyzing attributes of data (including constraints or business rules), redundancy, and dependencies, thereby identifying problems such as non-uniqueness of primary keys or other identifiers, orphaned records, incomplete data, and so on. State-of-the-art data integration technology provides data profiling facilities for structured databases, but is of little value when used with documents or messages. Data cleansing is the process of discovering and correcting erroneous data values. Data normalization is the process of converting data values to equivalent but standard expressions. For example, all abbreviations might be replaced with complete words, all volumes might be converted to standard units (e.g., liters) or all dates might be converted to standard formats (e.g., YYMMDD). Data validation is the process of confirming that data values are consistent with intended data definitions and usage. Data definitions and usage are usually captured as rules (constraints) concerning permissible data values and how some data values relate to co-occurring data values of other data elements, and possibly very complex. The process of data validation involves some method of determining whether or not data values are then consistent with those rules. Through data profiling, cleansing, normalization, and validation, data transformation is made more reliable and robust.

State of the art integration technology makes use of transformation software (a.k.a. transformation engine or integration broker) to transform the values of data elements of an incoming or source document into corresponding values in the desired or destination document format. Transformation engines are capable to altering the format and structure of the document, changing format or data type of data values, simple value substitutions, limited normalization, and performing computations based on pre-defined transformation mapping and rules. They may also permit validation checks on value ranges and may perform limited data cleansing. However, they do not provide data profiling of documents and messages, nor are they driven by semantic models or mappings between semantic models.

Transformation mappings and rules are expressed in technical language and must be specified by trained technical personnel. Units of business data to be processed by the Transformation Manager are usually classified into document types. In general, which transformation rules are applied to a document is determined by the type of document that is received and not based on its content. Thus, because spurious errors are difficult to anticipate and so it is difficult to write corrective rules, such errors often result in either rejection of the document with subsequent manual processing, or processing of erroneous documents with costly impact. Furthermore, if the content and structure either of the source document or of the destination document change (due, for example, to business requirements or technology changes), the transformation rules must be modified accordingly, requiring costly and error prone maintenance of the rules system.

Both EAI and ETL tools provide transformations for simple, common functions or lookup tables. In the event that more complex transformations are required, tools often provide a means to incorporate custom programmatic solutions. EAI tools rarely provide more than rudimentary capabilities concerned with data quality or semantics mismatches.

It can be appreciated that data modeling and translation have been attempted in various forms for years. Typically, such tools are comprised of XSLT based column-mappers or Extraction Transformation & Loading (ETL) capabilities. Both these types of tools are primarily column-based syntactic tools. They feed in the content of one or more columns from the source data (consisting of a set of columns) to a transformation function and place the result of this function execution into a destination column.

There are several problems with the conventional tools. Conventional semantic modeling tools represent the source and destination documents or data repositories as a simple set of columns. Most of the concepts in a data source need a language that is far richer than a set of columns. Conventional mapping tools require manual specification of column equivalences with no assistance from automated agents and without influence of semantic models. When the source and destination column sets become large, this can be a time consuming and tedious process that is error prone.

Sometimes, similar source documents such as a set of Purchase Orders from different customers will vary in length, structure, and format. In these situations, traditional mapping tools have to be calibrated individually for each of these documents. For example, customer A uses an SAP-IDOC of 200 lines, another customer B uses SAP-IDOC but with only 120 lines. Furthermore, there is a difference in the way the line values are interpreted. Customer B uses Item Description field for representing Part Number whereas Customer A uses Item Description for Part Description. Unlike the current invention which handles this situation automatically, traditional mapping tools require manual mapping of each of these source documents to the corresponding destination document.

Traditional mapping tools often depend on identifying name-value pairs in such documents. If a valid name-value pair exists (even if the value is incorrect or incomplete), the value is assumed valid. Unlike the current invention, traditional mapping tools cannot detect or correct certain types of errors. As an example of such an error, suppose Item Description is the name and the valid value is the Part Description—‘Ceramic Coated Resistor’. In this case, the value is indeed valid, but is incorrect in the context and the ‘correct’ value should have been ‘Tantalium coated resistor’. As an example of a correctable error, suppose Color is the name and ‘Grey’ is the value. Furthermore, suppose the destination format requires that the color be standardized as ‘Gray’, a correctable error which traditional mapping tools cannot handle.

Conventional transformation tools provide full-fledged functions that can only be coded by a sophisticated software developer. This person generally will not be the best source of domain knowledge. The domain expert, on the other hand, is not necessarily a technical software development expert. The problem of having to represent transformations as sophisticated software functions is further exacerbated by the fact that a simple set of columns is a very emaciated way of representing and modeling a data source. XSLT-based transformation tools are strictly confined to transformations between markup data, like XML or HTML. This slows them down because of the overhead involved in parsing and generating XML. On the other hand, ETL tools are oriented towards any kind of column-formatted data but their orientation is primarily towards batch processing of large quantities of data.

Conventional approaches are neither driven by semantic models, nor do they provide tools for modeling the semantics of documents using concepts and vocabulary close to that used by business users. Various modeling tools exist in the prior art, including data, ER, and business process modeling. Both data and ER (entity-relationship) modelers model data sources and their vocabulary is limited. Business process modeling is more concerned about modeling processes, usually as directed graphs representing business activities, decisions, and process flows, with the data exchanged in a process having a minor role.

Although not in the prior art, Patent Application 20030088543, filed Oct. 7, 2002—a month after the Provisional Patent Applications on which the priority current invention is based were filed (Aug. 8, 2002)—by Skeen, et. al., come closest to the subject matter of the present invention. Unlike the present invention, they describe a vocabulary-driven approach to data transformation with the vocabulary being derived in part from an ontology. In contrast to the present invention, Skeen's approach is more complex, requiring the additional effort of building, accessing, and using vocabularies. It also depends exclusively on the steps of applying resolution rules and naming rules mediated by a common vocabulary in the process of the transformation.

Furthermore, Skeen's approach is not compatible with the more general and flexible use of semantic models (i.e., it pertains only to a specific type of semantic model, namely ontologies), does not use semantic model to semantic model mappings, does not incorporate a validation step, and does not drive the transformation directly from model mappings. Finally, it does not reduce the complexity of the implementation by constraining the semantic models to the context of the transformation, thereby enabling both usability and performance benefits.

Semantics in the Prior Art

The problem of mapping semantically disparate data sources is well known both in EAI and ETL. As will be well-known to those familiar with the art, any EAI or ETL solution which addresses semantics requires methods for “creating and representing semantic models” (i.e., modeling data semantics), accessing semantic information, and reconciling data transformations with those semantics. One important method for modeling data semantics (representing knowledge) is to use an ontology (see, for example, Sowa, 2000). Other methods (such as metadata repositories and semantic networks) will be obvious to those of ordinary skill in the art. Note that a semantic model is not merely a collection of metadata about data elements (e.g., a common database catalog), but also serves to describe the semantic relationships among concepts.

An ontology is a formal representation of semantic relationships among types or concepts represented by data elements (by contrast, a taxonomy is relatively simple and informal). Much research has been done on computer representation of ontologies (e.g., Chat-80, Cyc), description and query languages for knowledge representation and ontologies (e.g., Ontolingua, FLogic, LOOM, KIF, OKBC, RDF, XOL, OIL, and OWL), rule languages (e.g., RuleML) and tools for building ontology models (e.g., Protégé-2000, OntoEdit). Typically, an ontology is represented as a set of nodes (representing a concept or type of data element) and a set of labeled and directed arcs (representing the relationships among the connected concepts or types of data elements).

Ontologies are generally used to augment data sources with semantic information, thereby enhancing the ability to query those sources. Much research has been done on the subjects of ontology modeling, ontology description and query languages, ontology-driven query engines, and building consolidated ontologies (sometimes called ontology integration). More recently, work has begun on developing master ontologies and ways to tag data so that information available on the World Wide Web can be queried and interpreted semantically (the Semantic Web).

A few products exist that attempt to solve the problem of data integration with transformation driven by semantics. Of those that do exist, all use a semantic hub approach. Contivo (www.contivo.com) maintains a thesaurus of synonyms to aid mapping and “vocabulary-based” transformation) and non-semantic transformation rules, and uses models of business data, but does not discover or create knowledge models or ontologies. The thesaurus is able to grow as new synonyms are identified. It will be appreciated by one of ordinary skill in the art that mapping of data element names and values based on synonym lookup is extremely limited, elemental, and inflexible by contrast with the present inventions use of mappings between semantic models.

Modulant (www.modulant.com) builds a single, centralized “abstract conceptual model” to represent the semantics of all applications and documents, mining and modeling of applications to produce “application transaction sets” which are “logical representations of the schema and the data of an application,” and then transforms source documents at runtime into the common representation of the abstract conceptual model and then into the destination documents. It will be appreciated by one of ordinary skill in the art that this approach fails to maintain separation of the semantic models of sources and targets, to provide a source semantic to target semantic mapping, and so cannot provide many of the benefits of the present invention including, by way of example, the reduced complexity obtained by building multiple categories of semantic models (such as application domain and topics), maintenance of document semantics independent of a common semantic model, or runtime transformation of documents that is driven by such a mapping. Unicorn (www.unicorn.com), like Modulant, uses a semantic hub approach and suffers from the same deficiencies by contrast with the present invention.

Weaknesses in the Current State of the Art

Research and industry publications have suggested using ontologies for integration, but have failed to disclose the method and architecture of the present invention. Calvanese and De Giacomo (2001) discuss the use of description logics for capturing complex concepts in ontology to ontology mapping, but do not disclose a method or architecture as in the present invention.

Omelayenko (2002) discusses the requirements for ontology to ontology mapping of product catalogs, but does not provide a solution to the problem. The paper also reviews what it states are the two ontology integration tools produced by the knowledge engineering community which provide solutions to ontology merging: Chimaera and PROMPT. These tools do not address the issue of transforming, cleansing, normalizing, profiling, and validating documents where the source and target documents are described by mapped ontologies. The paper concludes that neither tool meets all the requirements previously established. Chimaera is described in more detail in McGuiness, et al (2000). PROMPT is described in more detail in Noy, et al (2000).

Linthicum (May 2003) discusses the research being done by the WorldWide Web Consortium regarding the Semantic Web, RDF, and OWL (Web Ontology Language), and their potential uses in aiding application integration. These efforts are being designed to permit automated lookup of semantics in various horizontal and vertical ontologies, but do not pertain to either a method or an architecture for document transformation based on multiple, independent domain ontologies. The goal is described to be binding together diverse domains and systems “ . . . together in a common ontology that makes short work of application integration, defining a common semantic meaning of data. That is the goal.” By contrast, the present invention accepts the fact that diverse systems and domains may well have incompatible semantics and that a common ontology may even be undesirable.

Pollack (Oct. 2001) discusses some of the problems of semantic conflicts and integration, and the use of ontologies to represent semantics, but does not offer a solution to the problem. Osterfelt (June 2002) briefly discusses a definition of ontologies, but concludes that “the main problem with implementing an ontology within an EAI framework is complexity,” ultimately requiring that we “ . . . need to move forward in developing an ontology to support it <EAI> step-by-step, application-by-application and project-by-project.” Although stating a goal of “building an ontology to support EAI”, no solution is offered even for this, let alone a method or architecture to meet any of the objectives of the present invention such as mapping between distinct domain ontologies or using domain knowledge to automate document transformation

In addition to the deficiencies cited above, another problem with the conventional approaches has been that they are not built to handle drift in the subject domain (e.g., changes to the meanings and relationships among terms) or iterative knowledge acquisition effectively. Any non-trivial changes lead to redoing the entire data transformation, normalization, cleansing, profiling and validation process, and overwriting the past data or analytics in the process. Conventional approaches rely on enormous amount of manual labor requiring highly technical programmers and domain experts to work in tandem, both of whom are key resources with limited availability. There are no automated aids to help this process and hence change becomes even more of a burdensome process because of the amount of manual labor and time involved in coding the change repeatedly.

### SUMMARY OF THE INVENTION

In view of the foregoing disadvantages inherent in the prior art, the present invention introduces a computer software architecture and method for managing data transformation, normalization, profiling, cleansing, and validation that combines and uses semantic models, mappings between models, transformation rules, and validation rules. The present invention substantially departs from the conventional concepts and designs of the prior art, and in so doing provides an apparatus primarily developed for the purpose of flexible and effective data transformation, normalization, cleansing, profiling and validation which is not anticipated, rendered obvious, suggested, or even implied by any of the prior art, either alone or in any combination thereof.

The best method of the present embodiment of the invention, which will be described in more detail below, comprises a knowledge engineering sub-method and a transformation sub-method. The knowledge engineering sub-method creates and stores multiple semantic models derived from and representing the semantics of source documents, destination documents, other related documents, and categories of knowledge. These semantic models typically incorporate source or destination attributes, and category attributes (i.e. those specific to the category of knowledge the semantic model describes). Semantic models may be Domain semantic models represent knowledge about a particular domain of application and further comprise a set of topic semantic models, each representing knowledge about a particular topic within a domain. In addition, referent semantic models represent knowledge about a source or destination, and component semantic models represent semantic models about any other types of knowledge needed by the system. (This division of semantic models, rather than creating a single monolithic model, is essential to reducing the complexity and enabling performance.)

The knowledge engineering sub-method comprises the major steps of:

capturing semantic models by a combination of automated importation, pre-defined templates, and manual entry and refinement; and,

selecting a domain, source semantic model, and a destination semantic model, and creating, editing, and storing a mapping between these semantic models.

The transformation sub-method uses the mapping between semantic models, as created in the knowledge engineering sub-method, to drive transformation of a source document into a destination document.

The transformation sub-method comprises the major steps of:

accessing the source document;

identifying and categorizing a document's domain, source, and intended destination;

accessing the mapping corresponding to the source and destination for the domain;

performing any validations and transformations specified by the mapping; and,

writing the destination document.

The architecture comprises both DKA (Domain Knowledge Acquisition) components and Transformation components. The DKA components include a Semantic Model Server with a Semantic Modeler interface and a Model Mapper interface, a Rules Engine, a Transformation Manager, a Validation Manager, Adapters, Interactive Guides, and a Repository. These components are used to access sources of semantic information, create seed semantic models for specific domains, define and extend domain semantic models, create semantic maps among those semantic models, define business rules and validation rules, and to compile and store rules and semantic models in a data store for subsequent use.

The Transformation components of the architecture consist of Adapters, a Transformation Manager, a Validation Manager, a Rules Engine, and a Repository. These components are used to acquire source documents, validate and transform the source documents, validate the destination documents, and to write the transformed and validated document to the destination.

To the accomplishment of the above and related objects, this invention may be embodied in the form illustrated in the accompanying drawings, attention being called to the fact, however, that the drawings are illustrative only, and that changes may be made in the specific construction illustrated.

There has thus been outlined, rather broadly, the more important features of the invention in order that the detailed description thereof may be better understood, and in order that the present contribution to the art may be better appreciated. There are additional features of the invention that will be described hereinafter.

It will be readily apparent to one familiar with the art that the current invention: (1) significantly improves the ability of businesses to automate data communications between disparate applications and business entities; (2) provides improvements over traditional methods with respect to establishing and maintaining semantic integrity; (3) enables both guided and automatic correction of business documents (such as purchase orders and invoices); (4) enables ongoing management of business document transformation driven by business semantics that change over time; and, (5) provides an incremental approach to deployment.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is the Design-time Architecture of the System

FIG. 2 is the Runtime Architecture of the System

FIG. 3 is the Semantic Modeler Flow Chart

FIG. 4 is the Model Mapper Flow Chart

FIG. 5 is the Transformation Flow Chart

### DETAILED DESCRIPTION OF THE DRAWINGS

Turning now descriptively to the drawings, in which similar reference characters denote similar elements throughout the several views, the attached figures illustrate an embodiment of the architecture (referred to in the PPA as an “infrastructure”) for data transformation, normalization, cleansing, profiling and validation, comprising the components of the Semantic Modeler, Model Mapper, Transformation Manager, Validation Manager, Rules Engine, Repository, Interactive Guides, and Adapters.

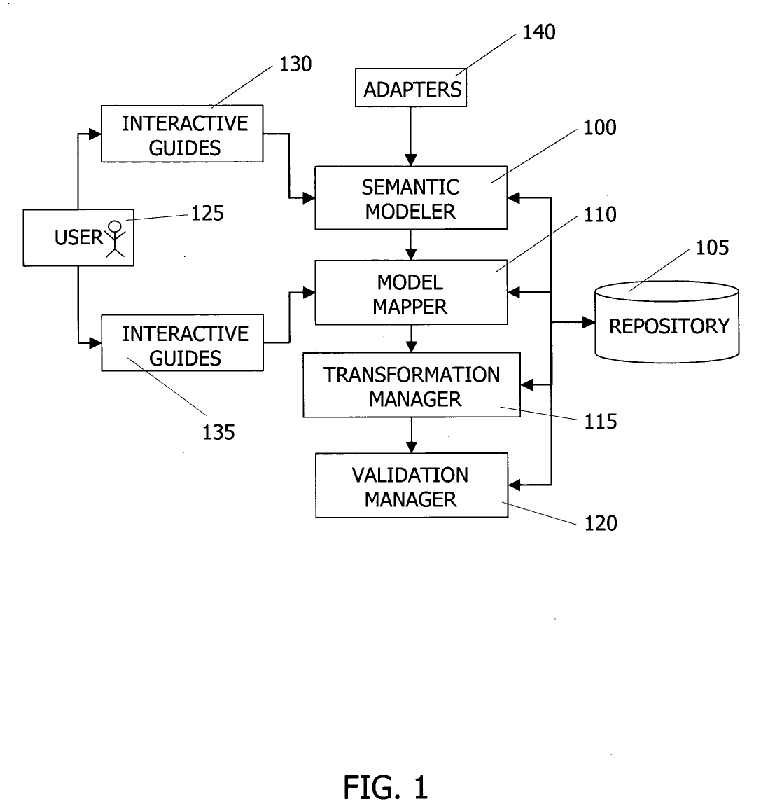

FIG. 1: The Design Time Architecture of the System shows the relationship among Domain Knowledge Acquisition components in one embodiment of the present invention. Semantic Modeler 100 builds the semantic models for sources, destinations, domains, topics, and components, which are then stored in the Repository 105. Model Mapper 110 retrieves source and destination semantic models for a desired domain, associates concepts and relationships in one to concepts and relationships in the other, and then stores the resulting model mapping in the Repository 105. Transformation Manager 115 captures data transformation rules from a user 125 and stores them in the Repository 105. Validation Manager 120 captures constraints on the data from a user 125 and stores them in the Repository 105. Interactive Guides 130 and 135 aid the user (typically a business user or domain expert), and mitigate a portion of the manual labor involved in both deriving semantic models using the Semantic Modeler 100 and specifying mapping between semantic models using the Model Mapper 110. Adapters 140 for metadata are used to provide, for example, to provide seed semantic models 145 to the Semantic Modeler 100.

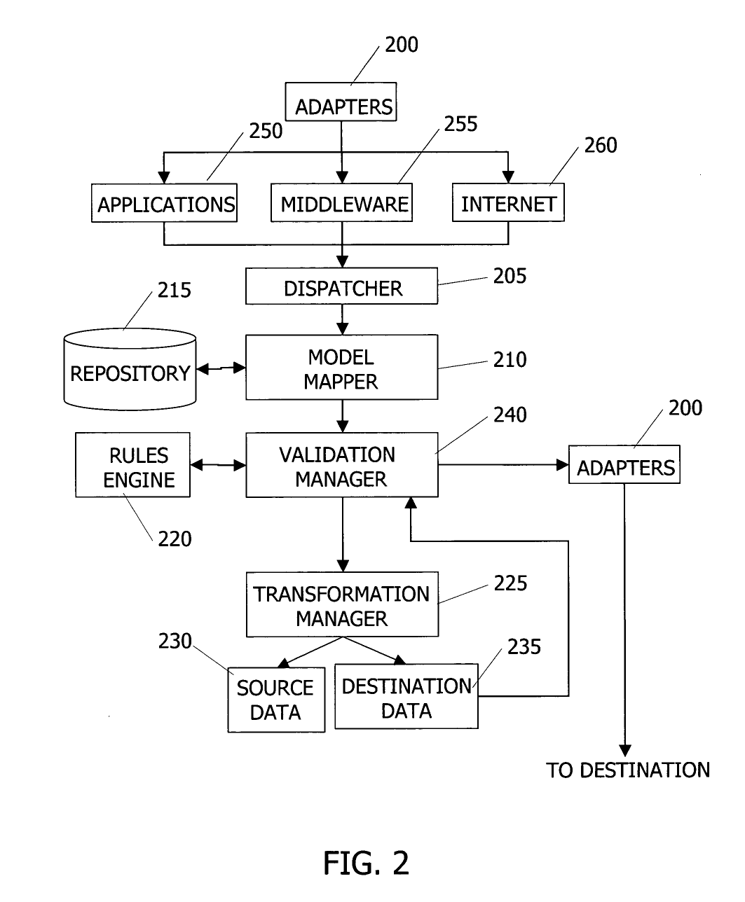

FIG. 2: The Runtime Architecture of the System shows the relationship among components used for data cleansing, normalization, transformation, and validation in one embodiment of the present invention. Adapters 200 for data provide specialized interfaces to external systems including, for example, applications 250, middleware 255, the Internet 260, and so on. Adapters 200 deliver data documents to the Dispatcher 205 which identifies the data source characteristics, the data destination characteristics, and retrieves a reference to the appropriate model map 210 from the Repository 215. It then forwards the data and the model map reference to the Validation Manager which accesses the model map and validates the source as required by the model map via the Rules Engine 220. The validated source data and model map is then forwarded to the Transformation Manager 225. The Transformation Manager then transforms the source data 230, creating the destination data 235 according to the model map and via the Rules Engine 220. The model map and destination data are then returned to the Validation Manager 240, which validates the destination data as required by the model map via the Rules Engine 220. The validated destination data is then forwarded to the destination via an Adapter 200.

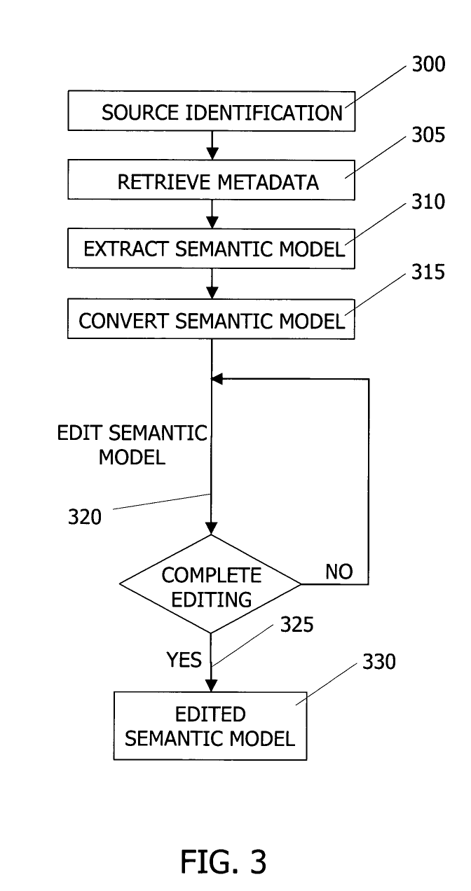

FIG. 3: The Semantic Modeler Flow Chart describes the major steps of one embodiment of the present invention in creating a semantic model. First, a source identification for knowledge acquisition is obtained from a user 300. Next, the metadata is retrieved from the source 305. Semantic information is then extracted from the metadata 310 and converted to an initial semantic model 315. The initial semantic model is edited in a loop by a user 320 until no more changes are desired 325, at which point the edited semantic model is stored 330.

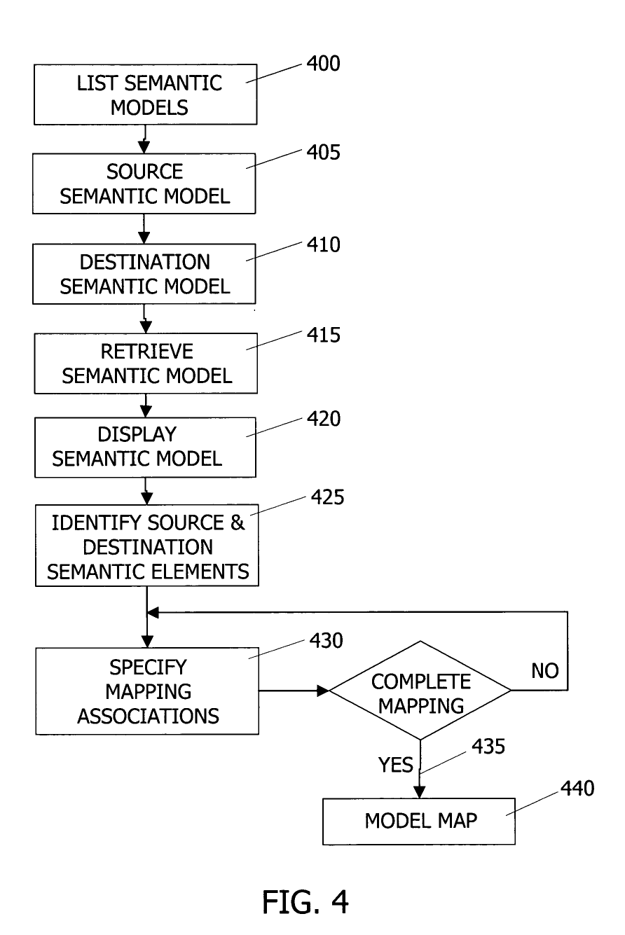

FIG. 4: The Model Mapper Flow Chart describes the major steps of one embodiment of the present invention in creating a mapping between semantic models. First, a list of semantic models is presented to the user 400. Next, a semantic model is selected 405 as the source and a semantic model is selected 410 as the destination. These are then retrieved from the repository 415 and presented to the user 420. The user then identifies elements of the source semantic model and elements of the destination semantic model to be mapped 425, and specifying associations between these elements 430. When no more elements are to be mapped or the user is done 435, the set of associations among elements is stored as a model map 440.

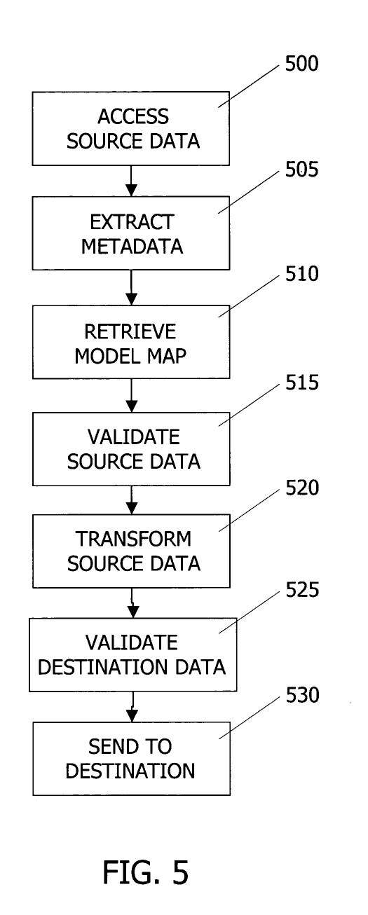

FIG. 5: The Transformation Flow Chart describes the major steps in transforming data in one embodiment of the present invention. First, the source data is accessed 500. Then selected metadata (source, destination, domain, and data characteristics) are extracted from the source data 505. Next, the model map corresponding to those characteristics is retrieved from the repository 510. The source data is then validated according to the model map and validation rules in the semantic model corresponding to the source 515. Then the validated source data is transformed according to the model map and transformation rules 520. The destination data is then validated 525 and sent to the destination 530.

### DETAILED DESCRIPTION OF THE INVENTION

The method of the present invention, summarized above and which will be described in detail below, comprises a knowledge engineering sub-method and a transformation sub-method.

The knowledge engineering sub-method creates and stores multiple semantic models derived from and representing the semantics of source documents and destination documents, as well as related documents. These semantic models have source or destination attributes and domain attributes. Domain semantic models represent knowledge about a particular domain of application and further comprise a set of topic semantic models (described further below), each representing knowledge about a particular topic within a domain. In addition, referent semantic models represent knowledge about a source or destination, and component semantic models represent semantic models about any other types of knowledge needed by the system. (This division of semantic models, rather than creating a single monolithic model, is essential to reducing the complexity and enabling performance.)

The knowledge engineering sub-method comprises the major steps of:

capturing source and destination semantic models by a combination of automated importation (including semantic mapping), pre-defined templates, and manual entry and refinement; and,

selecting a source semantic model and a destination semantic model, and creating, editing, and storing a mapping between these semantic models (model mapping).

Note that model mapping, as used herein, is distinct from semantic mapping. The latter is the process of converting data schemas into semantic models (including, for example, ontologies). Note also that, by contrast with the prior art, the knowledge engineering sub-method does not create a single semantic model of the combination of all sources and destinations or of all domains into a “universal” semantic model, nor does it use such a single semantic model as a common reference into which source documents are transformed and from which destination documents are created, a method sometimes known as semantic mediation or a semantic hub approach (i.e., using a “universal” semantic model to mediate document transformation). The creation of a single semantic model is not an explicit goal of the knowledge engineering method.

Rather, in the current best embodiment of the present invention, knowledge is captured as a set of domain, referent (source or destination specification), and topic semantic models with relevant mappings between them. Herein, a topic semantic model describes the semantics of a particular topic within a domain. Thus, for example, semantic models of Parts, Products, Plant Locations, Vendors, and so on might each be topic semantic models. A set of topic semantic models, inter-related by model mappings, may combine to form a semantic model of an application domain or domain semantic model (e.g., Electronics Supply Chain). A set of semantic models may be restricted by mapping to a particular referent (e.g., Suppliers or Company A).

This approach of creating and manipulating knowledge through multiple, fine-grained, and inter-related semantic models improves both usability and performance by limiting the complexity of:

the knowledge engineering problem (e.g., semantic mapping and mining of data schemas) it being difficult, by contrast, to combine semantic information from disparate sources;

querying the repository in which semantic models are stored, as universal semantic models often contain ambiguous or even contradictory semantics; and,

mapping between semantic models using model mapping, restricting the scope of the specific semantic models.

The transformation sub-method drives transformation of a source document into a destination document based on a mapping between the appropriate semantic models describing the semantics of those documents and as created in the knowledge engineering sub-method.

The transformation sub-method comprises the major steps of:

accessing the source document;

identifying and categorizing a documents source and its intended destination;

accessing the mapping corresponding to the source and destination;

performing any validations and transformations specified by the mapping; and,

writing the destination document.

The conceptual architecture comprises both DKA (Domain Knowledge Acquisition) components and Transformation components. The DKA components (design time components) include a Semantic Modeler and a Model Mapper, a Rules Engine, a Transformation Manager, a Validation Manager, Adapters, Interactive Guides, and a Repository. In combination, these components access sources of semantic information such as the Repository, create seed semantic models, access any template semantic models for specific domains, define and extend domain semantic models, create semantic maps among those semantic models, define business rules and validation rules, and compile and store both rules and semantic models in a data store for subsequent use.

The Transformation components (runtime components) of the architecture consist of Adapters, a Transformation Manager, a Validation Manager, a Rules Engine, and a Repository. These components acquire source documents, identify the destination document, retrieve the model mapping, validate and transform the source documents, validate the destination documents, and write and route the transformed and validated documents to their intended destinations. Each of these operations is driven by the retrieved model mapping corresponding to the source and destination.

Each of the components are further detailed and explicated below in the context of the preferred and other embodiments of the present invention. Possible implementations of each of the particular components are within the state of the art of software developers specializing in the fields of data transformation, application integration, and knowledge engineering.

Preferred Embodiment

In the preferred embodiment, the semantic models are ontologies. By way of example, and without limitation to the possible embodiments of the present invention, we use the terminology of ontologies to further describe the detailed steps of the knowledge engineering sub-method and the transformation sub-method.

Knowledge Engineering

The knowledge engineering sub-method models and captures the semantics of the business domains of interest in the form of a set of ontologies and a set of rules, using DKA (Domain Knowledge Acquisition) components. Schema and other semantic information pertaining to each data source and each data destination are captured as a set of ontologies. The selection of topics pertaining to an application domain are pre-determined and maintained in templates in the Repository. Thus, for example, a template for Electronic Supply Chain applications would include a list of relevant topics including, for example, Parts, Products, Suppliers, Vendors, and so on. The template might also include, for example, known and standard relationships and associations among these topics. The template might also include pre-defined or standard rules.

In the first major step of the knowledge engineering sub-method is to create a semantic model (such as an ontology) pertaining to each source or destination for a particular domain. The business user or domain expert uses the Semantic Modeler as follows:

import schema information as desired and where available using an appropriate Adapter, including possibly direct access to the native Repository;

using automatic semantic mapping techniques and methods well-known to those of ordinary skill in the art, and possibly including templates, create initial seed semantic models (possibly empty); and,

edit the seed semantic models as desired using the editing facilities of the Semantic Modeler, reviewing and augmenting the concepts, their relationships, and constraints.

The second step of the knowledge engineering sub-method is to capture knowledge pertaining to validation. The business user or domain expert uses the Validation Manager to:

capture concept relationships and constraints (including those for cleansing and validation) as rules where those relationships and constraints are not most directly captured in the semantic models; and,

store those rules in the Repository where they may be subsequently accessed by the Rules Engine.

The third major step of the knowledge engineering sub-method, once the necessary semantic models have been created, is to specify the mapping and transformations between data source and data destinations so that data translation and normalization can be achieved. This is done through the Model Mapper. Concepts (represented in an ontology, for example, as nodes) in the source semantic model are mapped to concepts in the destination semantic model, where each such concept mapping is mediated by associations and transformation rules.

The business user or domain expert uses the Model Mapper to create and edit mappings between relevant semantic models comprising the steps of:

identifying and accessing the semantic models relating to a source document;

identifying and accessing the semantic models relating to a destination;

selecting a concept from those presented to the user and pertaining to the source;

associating the source concept with a concept from those presented to the user and pertaining to the destination, obtaining system help as needed;

defining the association and any relevant transformation rules;

storing the association in the Repository as part of the model mapping;

proceeding until all necessary concepts are mapped in this manner; and,

further editing the associations as needed.

Next, the fourth major step of the knowledge engineering sub-method is to complete the model mapping. A business user or domain expert completes the model mapping, using the Transformation Manager user interfaces to:

capture mapping relationships and constraints (including those for cleansing and validation) as rules where those relationships and constraints are not most directly captured in the semantic model itself, and,

store those rules in the Repository where they may be subsequently accessed by the Rules Engine.

In the preferred embodiment, semantic models pertaining to topics within a distinct application domain of interest are distinct, though possibly inter-related by one or more model mappings. This modular approach permits the current invention to limit the complexity of knowledge engineering by the business user or domain expert, the computational complexity of semantic model maintenance, and the performance cost of transformations driven by the model mapping. Where possible, data validation constraints have been captured as part of the semantic model and thus may relate to either the source or the destination depending on what the semantic model describes. Any remaining validation constraints are captured as data validation rules in a data store (i.e., the Repository).

In the preferred embodiment and as a step between the knowledge engineering sub-method and the transformation sub-method, a Domain Knowledge Compiler generates representations of semantic models, templates, mappings, schemas, patterns, data, and tables in a form suitable to run-time processing from the knowledge captured by the knowledge engineering sub-method. Methods and techniques for this purpose will be readily apparent to one of ordinary skill in the art. For example, and without limitation of the possible embodiments, rules may be compiled into Java Beans.

Transformation

In the preferred embodiment, the transformation sub-method uses mappings between semantic models as created in the knowledge engineering sub-method to drive transformation of a source document into a destination document.

In the first major step of the transformation sub-method, a source document is received via an Adapter. The Adapter provides an interface to the source, eliminating the need for other components of the architecture to directly support a wide variety of protocols and formats. As noted above, a document may be a carrier of data and/or metadata.

Next, the second major step, the source and intended destination are identified. Various methods for identification of the source and intended destination are well-known and will be obvious to those of ordinary skill in the art. For some types of documents, both the source and destination identification are embedded. For others, the document contains a type identifier, name, or other equivalent content which may be mapped to determine the source and intended destination. For yet other documents, the semantic structure of the document may be used to identify or limit either the source or the intended destination. For still others, a human user may specify either the source or the intended destination.

In the third major step, the mapping corresponding to the source and destination is retrieved from the Repository based on the preceding identifications. The mapping comprises a set of associations and transformation rules between concepts, and any validation rules for elements of the source or destination documents. The instances of concepts are represented by specific data values in the source document and the destination document.

In the fourth major step, the Validation Manager verifies that the source document satisfies source validation rules. The Transformation Manager then transforms the validated source document into the prescribed destination document. Finally, the Validation Manager verifies that the destination document satisfies destination validation rules.

In the preferred embodiment, both the Transformation Manager and the Validation Manager invoke the Rules Engine as necessary in order to execute rules. Additionally, certain validation rules are used to confirm that the semantics of the source document are compatible with the source semantic model.

In the fifth and final major step of the transformation sub-method, the validated destination document is sent to the destination via an Adapter. The Adapter provides an interface to the destination, analogous to the manner in which an Adapter receives the source document. The use of Adapters eliminates the need for other components of the architecture to directly support a wide variety of protocols and formats.

In another embodiment, a Dispatcher routes received documents. From time to time, it may be valuable to map a source semantic model directly to a destination semantic model. The Dispatcher determines whether a received document is a semantic model or a data document. If the document is a semantic model (such as an ontology), it is passed to the Transformation Manager which is instructed to look up the corresponding destination semantic model. Otherwise, the document is transformed as data in the usual manner.

In one embodiment of the present invention, a standard knowledge description and query language, such as the Open Knowledge based Connectivity (OKBC) standard, is used to represent some knowledge (for example, semantic models) in the system.

In another embodiment compatible with the preferred embodiment of the present invention, the Semantic Modeler is augmented with access to the Validation Manager and Transformation Manager, and uses them to be used to perform profiling, data cleansing, normalization, transformation, and validation. This is particularly useful, for example, when a document is imported for semantic mapping, semantic resolution, and document abstraction.

In another embodiment, the system is provided with a semantic model version management capability. Methods for semantic model version management are well known and will be familiar to one or ordinary skill in the arts of data modeling and knowledge engineering. In a preferred embodiment of version management, the facility provides accountability through explanations of end results (by back tracking changes), undo capabilities, and “what-if” capabilities for different knowledge states.

In another embodiment, and compatible with the preferred embodiment, system help is manifested as a combination of a standard text help system and Interactive Guides. Interactive Guides serve as assistants to semi-automate the process of identifying which source concepts should be mapped to which destination concepts. This is done by suggesting promising mappings to user (typically a person knowledgeable about the business) based on pre-defined rules and heuristics, thereby significantly simplifying this aspect of the knowledge engineering task. For example, such rules might be based on matching of concept names and their synonyms as stored in a thesaurus, or on sub-graph matching algorithms.

In another embodiment, the Semantic Mapper is augmented with an Interactive Guide to aid the process of creating transformations from a source to destination.

In the preferred embodiment of the present invention, error handling is incorporated as necessary in such places and conditions as would be obvious to one of ordinary skill in the arts of software engineering and of commercial software design and development.

In yet a further extension, at least one Interactive Guide implements the ConSim method as described in detail below.

Other objects and advantages of the present invention will become obvious to the reader and it is intended that these objects and advantages are within the scope of the present invention. Various embodiments functionally equivalent to those described above will be readily apparent to one of ordinary skill in the art.

Architecture

Each component of the architecture has many of the advantages of similar components found in the prior art, but the components are used in a novel combination and in a manner which adds many novel features. The result of the present invention is a new tool for data integration and data transformation which is not anticipated, rendered obvious, suggested, or even implied by any of the prior art, either alone or in any combination thereof.

In the preferred embodiment of the architecture, the architecture includes the following functional element types:

a Dispatcher for routing data among elements;

a Semantic Modeler for building domain semantic models of sources, destinations, and other objects;

a Model Mapper for associating related elements between source and destination semantic models;

a Repository for storing semantic models, model mappings, data, and rules;

a Transformation Manager for capturing transformation rules and applying them to the transformation of data;

a Validation Manager for capturing data constraints and applying them to data;

a Rules Engine for executing validation and transformation rules;

Interactive Guides for assisting in the processes of semantic modeling and model mapping; and,

Adapters for conversion of data to or from specialized formats and protocols.

Dispatcher

The Dispatcher determines how documents are to be routed and to which components of the system. The Dispatcher routes data to the appropriate component down stream. Various methods for implementing the functionality of the Dispatcher will be readily apparent to one of ordinary skill in the art.

A Dispatcher mechanism allows the system to be event (e.g., receipt of a document) driven. The need for users to determine which components to use for each particular document received is thus eliminated, providing a high degree of usability, efficiency, and responsiveness to real-time document processing. It also permits both knowledge engineering and transformation activities to take place simultaneously within the system, eliminating the need for, but without precluding, deployment of a separate system for knowledge engineering (design) and runtime transformation.

In the preferred embodiment of the present invention, the Dispatcher determines the routing of documents based on a routing table, or the functional equivalent of such a routing table, associating documents and components. The routing table may be imported, manually created, or else auto-generated during a post-design compilation phase. For example, and by way of illustration, documents of type meta-data might be routed to Semantic Modeler and documents of type data might be routed to the Transaction Manager. This provides a mechanism by which a software system having the preferred embodiment of the architecture can automatically respond in an appropriate manner based on which documents it receives.

Semantic Modeler

The Semantic Modeler is a knowledge acquisition and semantic model editing tool. It builds the semantic models both from the point view of data representations in the source and in the destination, suitably constrained to domains. Numerous methods for building a Semantic Modeler will be readily apparent to those of ordinary skill in the art.

In the preferred embodiment, the Semantic Modeler implements semantic models using ontologies. This has the benefit of allowing the concepts and vocabulary used to be very close to that used by domain experts.

In a further extension of the preferred embodiment, the Semantic Modeler imports metadata by invoking an Adapter appropriate to a data or metadata source. As noted below, the Adapter may be as simple as a read or write access method for a native file, XML, or the Repository, or it may be a sophisticated as to embed complex methods for metadata extraction and seed semantic model creation from Web Services and WSDL. Such methods are well-known to those familiar with the art of software engineering.

Model Mapper

The Model Mapper maps related concepts, relationships, and other elements in the source and destination semantic models. A model map is an abstraction that conceptually consists of a set of source semantic model elements, a set of destination semantic model elements, and a set of associations among those elements. Thus a model mapping between two semantic models may be considered a set of mappings between some elements of those two semantic models. Associations specify how to obtain, lookup, compute, or otherwise identify an instance of an element in the destination semantic model from an instance of an element in the source semantic model.

A variety of methods for creating maps between semantic models will be readily apparent to those of ordinary skill in the art, although the prior art describes such facilities primarily for consolidation or integration of those semantic models. By contrast, it is the primary objective of the Model Mapper in the present invention to preserve model mappings in such a manner that they may be subsequently used by either the Transformation Manager or the Validation Manager to enable data transformation among data sources modeled by these semantic models.

In the preferred embodiment, the Model Mapper provides an intuitive, drag-and-drop GUI interface for the specification of associations between source and domain concepts.

In the preferred embodiment, the semantic models (e.g., data models with proper semantics, ontologies, XML schema, etc.) for mapping are loaded into a mapping specification panel, where a human user relies on intuitive GUI tools to specify the associations among concepts or data columns (as the case may require). The associations thus established can involve direct equivalences, straight-forward mappings, functions, conditional rules, workflows, processes, complex procedures, and so on. The Model Mapper enables the Transformation Manager to effect real-time transformations from any kind of data format to any other kind of data format.

In one embodiment, the Transformation Manager acquires access to a combination of document sources and document destinations via at least one Adapter.

Validation Manager

Validation Manager embodies methods to capture certain data constraints from user input or other sources, and to apply those constraints to data. In particular, the Validation Manager manages data constraints are more suitably represented as (validation) rules rather than captured as constraints on and between elements of a semantic model. The Validation Manager invokes an instance of the Rules Engine to apply validation rules to data. Methods for capturing validation rules from user input and other sources, and for applying validation rules via a Rules Engine will be readily apparent to those of ordinary skill in the art of software engineering.

Transformation Manager

Transformation Manager captures data transformations from the user input or other sources, and applies them to the transformation of data. In particular, the Transformation Manager manages associations and transformations are more suitably represented as (transformation) rules rather than captured as associations or transformations on and among elements of a semantic model. The Transformation Manager invokes an instance of the Rules Engine to apply transformation rules to data. Methods for capturing transformation rules from sources such as user input and for applying transformation rules via a Rules Engine will be readily apparent to those of ordinary skill in the art of software engineering.

Rules Engine

The Rules Engine manages rules (including validation and transformation rules). It provides other components with query access to and update of a rules repository, and execution of appropriate rules based on input characteristics. Rules engines and methods to incorporate them into the present invention will be familiar to one of ordinary skill in the art.

In one embodiment, the Rules Engine uses the RETE net-based unification algorithms, and supports both forward chaining and back chaining. As will be obvious to one of ordinary skill in the arts of expert systems and data transformation, chaining is beneficial both in deriving complex transformations and in deriving explanations of those transformations.

Adapters

The Adapter is a software module that encapsulates methods for connecting otherwise incompatible software components or systems. It is the purpose of Adapters to extract the content of a source document and deliver it in a form which the recipient component of the system can further process, and to package content in a destination document and deliver it in a form which the destination can further process. Adapters may be fixed, integral components of the system or may be loosely coupled to the system. The uses of and methods for construction of Adapters are well-known to those skilled in the art of enterprise application integration.

In the preferred embodiment, the system incorporates an arbitrary number of loosely coupled Adapters, thereby enabling the system to connect to a variety of internal or external software components and systems for the purpose of reading or writing documents.

For the purposes of the present invention, Adapters can be classified into two types: Data Adapters and Metadata Adapters. Data Adapters are used to provide connectivity (some combination of read and write access) to data sources such as applications, middleware, Web Services, databases, and so on. For data that must be read from a particular data source, then transformed, cleansed, profiled, normalized, and the resulting data then written a particular data destination (different from the data source), the system will typically require the use of a Data Adapter to enable it to read from the data source and another Data Adapter to write the data destination.

In one embodiment of the present invention, a Data Adapter cleanses source data as it is accessed.

In another embodiment of the present invention, a Data Adapter normalizes destination data as it is sent to the destination.

Metadata Adapters (referred to as modules in the PPA) provide connectivity to metadata sources including, for example, a metadata repositories, the system catalogs of relational databases, WSDL (Web Services Description Language), XML DTDs, XML Schemas, and the like.

In an extension to the preferred embodiment of the present invention, a Metadata Adapter augments the Semantic Modeler enabling it to induce seed semantic models by accessing metadata. Many methods for converting schemas as expressed in metadata sources will be readily apparent to one of ordinary skill in the art. The seed semantic model thus created serves as a starting point for the business user to build a more elaborate semantic model rather than start from an empty semantic model.

In one embodiment of the present invention, the Metadata Adapter profiles data in a data source, thereby enabling the system to acquire metadata directly from data sources when access previously existing metadata does not exist.

In one embodiment of the present invention, at least one such Adapter is a SOAP Message Handler. The Adapter provides connectivity to Web Services, thereby enabling the present invention to effect real-time reconciliation of semantic differences and data transformation between interacting Web Services as will be readily apparent to those of ordinary skill in the art. The Adapter parses SOAP messages from requesting Web Services and hands off the payload to the Dispatcher. When the payload has been transformed, it is handed back to an Adapter. If that Adapter is also a SOAP Message Handler, it packages the payload as a SOAP message for the responding Web Service. Thus, the source and destination correspond to requesting and responding Web Services, respectively, and the Web Services are modeled using semantic models. The source semantic model comprises the semantics of the data from the requesting web service. The destination semantic model comprises the semantics of the data from the responding web service.

Repository

Repository components provide storage for knowledge about domains (ontologies, rules, and mappings) and for data. A variety of data stores (including, for example, relational database management systems, XML database management systems, object oriented database management systems, and files management systems) and schemas (including, for example, relational and XML) may be used for storing such data and metadata, as will be readily apparent to one skilled in the art. With respect to the present invention, and particularly the required functionality of the Repository, these data stores and schemas are functionally equivalent, although one or the other may exhibit better performance, easier access, and other beneficial characteristics.

Interactive Guides

Semantic modeling and model mapping can be labor intensive. The Interactive Guide provides advice to a business user regarding the tasks of semantic modeling and model mapping. It mitigates much of the manual labor involved in these tasks. In particular, the Interactive Guides are software components which interact with and aid the user. The Interactive Guide embodies one or more methods for advising user on selected tasks.

In one embodiment of the present invention, an Interactive Guide aids the user in creating semantic models via the Semantic Modeler.

In another embodiment of the present invention, an Interactive Guide aids the user in establishing mappings between elements of two or more semantic models via the Model Mapper. An Interactive Guide mitigates the work of a human user when, for example, creating associations between concepts and relationships in semantic models, or between columns in data models or XML documents. A current best method for providing suggestions to the user within the present invention is described in detail below (see the discussion of CoSim and Equivalence Heuristics).

When integrated with the Semantic Modeler, Model Mapper, or other data mapping tool, an Interactive Guide provides suggestions for mappings, resolution, concepts, and so on, which may be presented to the user in a variety of ways that will be familiar to one of ordinary skill in the art, including, for example, dynamically generated help text, annotations, Wizard, automatically generated graphical depictions of the suggested candidate mappings, and the like.

In one embodiment of the present invention, the content provided by the Interactive Guide is determined by the context of the user's actions within the user interface rather than being based on a user request for help and subsequent dialog. Methods for accomplishing the same exist in the prior art and will be well-known to one of ordinary skill in the art of user interface design.

This element of the present invention substantially departs from the conventional concepts and designs of the prior art pertaining to data integration and data transformation, and in so doing provide an apparatus primarily developed for the purpose of aiding mapping between ontologies, data models, XML documents, and the like.

In the preferred embodiment of the present invention, the use of Interactive Guides for aiding mapping between semantic models, data models, XML documents, and the like, mitigate many of the disadvantages of data mappers and model mappers found in the prior art. Furthermore, Interactive Guides provide many novel features for aiding mapping between semantic models, data models, or XML documents which is not anticipated, rendered obvious, suggested, or even implied by any of the prior art, either alone or in any combination thereof.

In a further refinement of the preferred embodiment of the present invention, at least one Interactive Guide is included in the system which uses the novel method of the CoSim control algorithm in conjunction with an extensible set of Equivalence Heuristics to provide advice to the user. The CoSim control algorithm and Equivalence Heuristics are both described in more detail below.

Equivalence Heuristics

Equivalence Heuristics are procedures which establish hypothetical equivalences or associations between semantic model elements, which may be subsequently refined, confirmed, or denied by either automated or manual (i.e., human input) means. For each possible or candidate mapping between source and destination elements, heuristics are used to compute a weight or probability that the mapping is viable. The weights determined by each heuristic for a particular candidate mapping are added together to obtain a total weight for that mapping.

These weights are used by the Interactive Guide to provide suggestions to the user as further described below. Equivalence Heuristics may be classified into a number of categories. These categories include, for example, syntactic, structural, human input, prior knowledge, and inductive heuristics, defined as follows:

Syntactic heuristics provide a measure of similarity between concept names (or strings) appearing in the source and the destination. In the preferred embodiment of the present invention, two syntactic heuristics are used. First, a candidate mapping receives a small weight when the stemmed concept strings (i.e., names of concept) for the source and destination elements contain significant substring match. Second, using a similarity measure such as that used in the vector model of information retrieval, an additional weight is added based on similarity of source concept definition and destination concept definition. Methods to calculate these and other heuristics of a syntactic nature will be readily apparent to one skilled in the art.

Structural heuristics provide a measure of similarity of concept names based on context. In the preferred embodiment of the present invention, a small additional weight is added to the total weight for each sibling, child, or ancestor relationship in the source for which a viable mapping to the like sibling, child, or ancestor relationship in the destination has been established.

Human input heuristics provides a measure of similarity of concept names based on external belief or knowledge. In the preferred embodiment of the present invention, human user input establishes the initial weights of mappings in a range of values representing 0-100% certainty, and the said weights for such mapping may be designated as fixed or may be subsequently altered by the system. By allowing human input of some portion of the mappings, these initiating portions can then be used to start the propagation of weights through the semantic model graphical structures. Using a standard method of weight propagation through graphs, the weights decrease with distance from the source concepts.

A priori heuristics provide a measure of similarity of two concept names based on weights stored in repository. In the preferred embodiment of the present invention, a priori weights may be stored in the repository in association with specific domains or categories of ontologies, and added to the total weight of the candidate mapping.

Inductive heuristics provide a measure of similarity based on data examples. Any data (structured or unstructured) that can be mapped to the leaf nodes of the source or destination ontologies can be exploited to identify similarities between source and destination semantic model concepts. In the preferred embodiment of the present invention, the similarity measure used is the same as that used in the vector model in information retrieval if the data is unstructured. If the data is structured, feature-based similarity measures are used.

In an extension to the preferred embodiment, a suitably authorized user may add additional heuristics or types of heuristics to the Interactive Guide, thereby extending the Equivalence Heuristics and modifying the behavior and effectiveness of the Interactive Guide. This extensibility may be accomplished by any of a number of means well-known to those skilled in the art as, for example, encoding the heuristic in a rule which may be evaluated by a rules engine when needed by the Interactive Guide.

CoSim Algorithm

The CoSim control algorithm uses weighted mappings between semantic model elements so that candidate mappings of higher weight can be suggested to the user by the Interactive Guide, or can be used to generate mappings automatically. The process of interaction between a user and Interactive Guide via the mapping tool follows a “Suggest, Get-Human-Input, Revise” cycle as shown in the CoSim control algorithm below. In absence of other information, any element (or grouping of elements) of a first semantic model might be related to any element (or grouping of elements) of a second semantic model and therefore must be considered to be a candidate mapping until eliminated. Once an element (or grouping of elements) in a semantic model is mapped, other candidate mappings involving that element (or grouping of elements) might be considered invalid. For example, a rule might set the weight of every mapping involving an already mapped element to zero, thereby effectively eliminating it from candidacy. The CoSim control algorithm comprises the following steps:

Calculate a weighted set of candidate mappings based on the set of available heuristics and current set of weights;

Eliminate invalid mappings;

Display the list or some portion of it to the user;

Obtain from the user confirmation of any mappings in the list which the user decides are correct, or else permit the user to stop; and,

Repeat until stopped by input from the user or until all elements of the semantic models are mapped.

In the preferred embodiment of the present invention, and by way of achieving further efficiency in the CoSim algorithm, the system identifies component weights that need only be calculated once and does not subsequently recalculate them.

In an extension to the preferred embodiment of the present invention, the user is presented the most heavily weighted suggested candidate mapping or mappings as these are the most likely to be correct.

In an extension to the preferred embodiment of the present invention, the content of the list to be shown to the user is based on weight.

In an extension to the preferred embodiment of the present invention, the size of the list to be shown to the user is based on a maximum number. In yet a further extension, that maximum number may be set or altered by the user.

In an extension to the preferred embodiment of the present invention, the potential entries in the list are based on a threshold weight. Entries below the threshold are not included in the list. In yet a further extension, the threshold may be set or altered by the user.

As a further extension to the preferred embodiment, the user may request and view an explanation of how the weight for each suggested candidate mapping was computed.

As yet a further extension to the preferred embodiment, the user may override any portion of the heuristically computed weight for a suggested candidate mapping.

In still another extension to the preferred embodiment, the user may alter the component weights contributed by any heuristic, thereby permitting the user to emphasize or deemphasize the importance of certain heuristics.

The scope of this invention includes any combination of the elements from the different embodiments disclosed in this specification, and is not limited to the specifics of the preferred embodiment or any of the alternative embodiments mentioned above. Individual user configurations and embodiments of this invention may contain all, or less than all, of the elements disclosed in the specification according to the needs and desires of that user. The claims stated herein should be read as including those elements which are not necessary to the invention yet are in the prior art and may be necessary to the overall function of that particular claim, and should be read as including, to the maximum extent permissible by law, known functional equivalents to the elements disclosed in the specification, even though those functional equivalents are not exhaustively detailed herein.

We claim:

1. A computer implemented method for integrating data, said method comprising:
creating at least a first and a second semantic model wherein said first semantic model is restricted to a first category of knowledge and said second semantic model is restricted to a second category of knowledge;
storing said semantic models;
mapping the stored first semantic model to the stored second semantic model, thereby creating a model mapping;
storing said model mapping;
accepting as input a first data associated with said first semantic model;
transforming said first data, according to said model mapping;
validating said first data according to a set of validation rules; and,
forwarding said transformed and validated first data to at least a first software system.

2. A method as in claim 1, wherein said step of mapping is further augmented with at least a third semantic model and said third semantic model is restricted to a third category of knowledge.

3. A method as in claim 1, wherein said first and second categories of knowledge pertain to a common application domain.

4. A method as in claim 3, wherein the common application domain is further modeled by at least one topic semantic model.

5. A method as in claim 4, wherein at least a first topic is associated with the common application domain and the said association is maintained in a template.

6. A method as in claim 5, wherein the template incorporates a second topic, relationships among the first and second topics, and at least one pre-defined rule.

7. A method as in claim 2, wherein said third semantic model is a referent semantic model.

8. A method as in claim 1, wherein at least one of the semantic models describes the semantics of a message.

9. A method as in claim 1, wherein at least one of the semantic models describes the semantics of a Web Service.

10. A method as in claim 1, wherein at least one of the semantic models describes the semantics of a business document.

11. A method as in claim 1, wherein at least one of the semantic models describes the semantics of an XML document.

12. A method as in claim 1, wherein at least one of the semantic models describes the semantics of a database.

13. A method as in claim 1, wherein the step of creating the semantic models may be augmented at the discretion of a human user by importing a set of semantic information.

14. A method as in claim 13, wherein the set of semantic information is imported by means of a first adapter.

15. A method as in claim 1, wherein the step of creating the semantic models includes user modification of at least one of the said semantic models.

16. A method as in claim 1, wherein the step of creating the semantic models includes augmenting the semantic models indirectly with at least one validation rule.

17. A method as in claim 1, wherein the step of creating the semantic models includes augmenting the semantic models indirectly with at least one transformation rule.

18. A method as in claim 1, wherein at least one of the semantic models is implemented as an ontology.

19. A method as in claim 1, wherein at least one of the semantic models is represented by a standard knowledge description and querying language.

20. A method as in claim 13, wherein the semantic information is processed according to at least a first rule in order to accomplish at least one of the operations of data profiling, semantic mapping, semantic resolution, data cleansing, normalization, transformation, and validation.

21. A method as in claim 1, wherein said step of mapping the stored first semantic model to the stored second semantic model further comprises:
selecting and accessing said first semantic model based on association with a source;
selecting and accessing said second semantic model based on association with a destination;
presenting the semantic models to a user;
eliciting selection of a first semantic element belonging to the first semantic model;
eliciting selection of a second semantic element belonging to the second semantic model;
establishing an association between the first semantic element and the second semantic element;
providing the option of using system help as needed;
defining each relevant transformation rule;
defining each relevant validation rule;
providing the option of storing the resulting model mapping;
permitting editing of the association; and,
storing the model mapping.

22. A method as in claim 21, where in the step of providing the option of using system help is accomplished using an Interactive Guide.

23. A method as in claim 22, wherein the method implemented by said Interactive Guide comprises the steps of:
creating at least one candidate mapping between elements of said first semantic model and said second semantic model;
assigning a weight to each said candidate mapping, said weight derived from one or more portions that may be individually computed;
evaluating each candidate mapping and eliminating any candidate mapping that is invalid;
presenting a set of one or more candidate mappings to a human user;
eliciting from the user selection of at least one weighted candidate mapping in the set; and,
modifying the model mapping according to the user selection.

24. A method as in claim 23, wherein the weight assigned to the candidate mapping is determined according to one or more heuristic rules, each of which determines a portion of said weight.

25. A method as in claim 24, wherein at least one heuristic rule is defined the user.

26. A method as in claim 24, wherein at least one heuristic rule is modified by a human user.

27. A method as in claim 24, wherein a first heuristic rule is pre-defined and a criterion of applicability of the heuristic rule is determined by a human user.

28. A method as in claim 23 wherein the system identifies those portions of the weight that cannot change on recalculation and does not recalculate them once they have been calculated.

29. A method as in claim 23, wherein the inclusion of each candidate mapping in the set is decided based on the weight of that candidate mapping.

30. A method as in claim 29, wherein the inclusion of each candidate mapping in the set is decided based on the weight of that candidate mapping exceeding a threshold.

31. A method as in claim 30, wherein the threshold may be modified by the user.

32. A method as in claim 23, wherein the number of candidate mappings included in the set is limited to a maximum number.

33. A method as in claim 32, wherein the maximum number may be modified by the user.

34. A method as in claim 23, wherein the user obtains an explanation of the weight of a selected candidate mapping was computed.

35. A method as in claim 23, wherein the user may modify any portion of the weight.

36. A method as in claim 23, wherein the user may modify the method by which the weight is derived.

37. A method as in claim 1, wherein the means of accepting data is via an Adapter.

38. A method as in claim 37, wherein the Adapter is a SOAP Message Handler.

39. A method as in claim 1, wherein the means of forwarding data is via an Adapter.

40. A method as in claim 39, wherein the Adapter is a SOAP Message Handler.

41. A general-purpose computer incorporating specific hardware and software for transforming, profiling, cleansing, normalizing, and validating data, wherein said specific hardware and software comprise:
means for defining at least a first semantic model and a second semantic model;
means for defining a model mapping among semantic models;
means for storing said semantic models and said model mapping;
means for defining validation rules and transformation rules;
means for accepting data from at least one source;
means for transforming said data according to the model mapping;
means for validating said data; and,
means for forwarding said data to at least one destination.
